(19) United States
(12) Patent Application Publication
(10) Pub. No.: US 2017/0374432 A1
(43) Pub. Date: Dec. 28, 2017

(54) SYSTEM AND METHOD FOR ADAPTIVE VIDEO STREAMING WITH QUALITY EQUIVALENT SEGMENTATION AND DELIVERY

(71) Applicant: VIDEOPURA, LLC, Delray Beach, FL (US)

(72) Inventor: Velibor Adzic, Boca Raton, FL (US)

(73) Assignee: VIDEOPURA, LLC, Delray Beach, FL (US)

(21) Appl. No.: 15/525,837

(22) PCT Filed: Nov. 13, 2015
(86) PCT No.: PCT/US2015/060606

§ 371 Date: May 10, 2017

Related U.S. Application Data
(60) Provisional application No. 62/079,555, filed on Nov. 14, 2014.

(51) Int. Cl. H04N 21/6373; H04N 21/2343; H04N 19/154; H04N 21/234; H04N 21/845; H04N 21/24

(52) U.S. Cl. CPC H04N 21/6373; H04N 21/8456; H04N 21/2408; H04N 19/154; H04N 21/23418; H04N 21/23439

(57) ABSTRACT

A system for adaptive streaming may include a video receiver configured to transmit a request for a video segment. A video analyzer may be configured to determine, for the video segment, a quality equivalence map between two or more bitrate levels. A video sender coupled to the video analyzer configured to select a bitrate level for the video segment based on an available bandwidth and the determined quality equivalence map. The video segment at the selected bitrate level may be transmitted to the video receiver.

This application claims priority to U.S. Provisional App. Ser. No. 62/079,555, titled “System and Method for Adaptive Video Streaming with Quality Equivalent Segmentation and Delivery”, filed Nov. 14, 2014, the disclosure of which is hereby incorporated by reference in its entirety.

### FIELD

The present application relates to video coding and video delivery, and more specifically, to adaptive digital video distribution.

### BACKGROUND

Growing demand in recent years prompted development of more flexible platforms for video delivery over the Internet. One such platform is the adaptive streaming. Adaptive streaming provides flexibility of delivering requested content at multiple bitrates, enabling better utilization of available bandwidth. A system for adaptive streaming illustrated in FIG. 1 may include a video receiver 100, a video sender 140 and a video description 120. Video receiver 100 can obtain a video description file 120 from a content service provider or other means such as email or messaging service. The source of media description can be a local or remote unit connected via link 110 to the receiver. The video description file 120 can include addresses (URLs, or uniform resource locators) of one or more video segments that make up the video content selected for download and playback. The video description file 120 can also contain meta data such as the coding formats, content encryption details, and available bitrates.

The segments of a video may be stored at a server that is connected to the receiver via a communication network. Video receiver 100 can request a video segment from a server using a means such as a HTTP (hypertext transfer protocol) request for a segment 130 using the URL for the segment at a specific bitrate. Video sender 140 can receive the request and sends video content as a response 150. Video sender 140 can be an HTTP server that just responds by delivering the requested URL. In order to provide flexibility in bandwidth consumption, adaptive streaming methods may provide segmentation of a source video sequence. The source video sequence can be divided into temporal sub-units called segments. Duration of a segment can be any length of time, such as between 2 and 10 seconds, or longer from a few minutes to the whole video sequence. In FIG. 2 one video sequence 200 can be segmented into a collection of segments 202. There can be a total of n segments 202 in the video sequence. In order to allow bandwidth flexibility each segment is encoded at K different bitrate levels 204, where bitrate level K is a higher bitrate than bitrate level K-1.

Generally, a video sender may send video segments encoded at the highest bitrate level that is allowed by the available bandwidth. However, there exists a need to allow an adaptive streaming system to send video segments encoded at lower bitrate levels in order to save bandwidth but without sacrificing perceived video quality. Further, since not all n segments at each of K bitrate levels may be delivered to the video receiver, there is a need to provide for the adaptive streaming system to store fewer bitrate encoded segments for each segment of a video sequence.

### SUMMARY

The present disclosure provides a system, which can be implemented as a part of the adaptive streaming sender, that removes redundant video segments, thus allowing for better utilization of available bandwidth while achieving the same quality of experience for the end user.

The disclosed subject matter can use content analysis algorithm that models subjective quality by correlating attributes of HVS (Human Visual System) to the content characteristics. A rate-distortion theory algorithm can be used to identify redundant segments while producing a quality equivalence map that can be used to lower the bandwidth consumption.

An exemplary system for adaptive streaming illustrated in FIG. 3 may include, for example, a video receiver 100 configured to transmit a request for a video segment 130. A video analyzer may be configured to determine, for the video segment, a quality equivalence map 220 between two or more bitrate levels. A video sender 140 is coupled to or connected to the video analyzer and is configured to select a bitrate level for the video segment based on an available bandwidth and the determined quality equivalence map 220. The requested video segment at the selected bitrate level may be transmitted 150 to the video receiver 100.

### BRIEF DESCRIPTION OF THE DRAWINGS

Further features, the nature, and various advantages of the disclosed subject matter will be more apparent from the following detailed description and the accompanying drawings in which:

FIG. 1 is a block diagram of a prior art adaptive streaming system;

FIG. 2 is a depiction of a set of segments provided by a prior art adaptive streaming system;

FIG. 3 is a block diagram of an adaptive streaming system in accordance with an embodiment of the disclosed subject matter;

FIG. 4 is a mapping of a reduced set of segments provided by an adaptive streaming system in accordance with an embodiment of the disclosed subject matter; and

FIG. 5 is a schematic describing system for generating a Quality Equivalence Map for input segments in accordance with an embodiment of the disclosed subject matter;

FIG. 6 is a schematic illustration of a computer system for video encoding in accordance with an embodiment of the disclosed subject matter; and

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

In certain adaptive streaming solutions such as Dynamic Adaptive Streaming over HTTP (DASH), Apple's HTTP Live Streaming (HLS) and Microsoft's Smooth Streaming (SS), a video receiver can be a client device, e.g., a personal computer, tablet, smartphone, broadband-enabled television, etc., that can determine or decide which segments to download ahead of playback. This decision is based on the bandwidth that is available at that moment. This means that receiver always downloads the segment at the highest bitrate permitted by bandwidth constraint.

For any video content delivery system, a goal is to provide the best quality of experience for end users. Quality of experience can be closely related to the perceived quality of video content, which can be achieved by using more bits to represent information. The relationship between the bitrate and quality of video signals is governed by the rate-distortion theory. Good quality is achieved by reducing the amount of distortion that is introduced during the coding process.

Certain coding algorithms try to achieve minimal distortion for a given bit budget. In general, in order to achieve better perceived quality of the video sequence more bits need to be spent to represent it. However, the relationship between bitrate and quality may not be a linear relationship, and the relationship may change depending on the content of the video (e.g., whether it depicts motion, high lighting or low lighting). Accordingly, differences between two levels in bitrate are not necessarily discernable when measured in perceived quality (e.g., when perceived by a user). Further, above certain bitrate levels, increasing bitrate of a streamed video may not provide an appreciable increase in perceived quality.

By requesting segments based on available bandwidth only, certain adaptive streaming systems may be introducing inefficiencies. First, the segments that are at a lower bitrate levels might have equivalent perceived quality. Second, although available bandwidth may allow for high bitrate levels, it can be more efficient to transmit segments that achieve a high perceived quality at a lower bitrate.

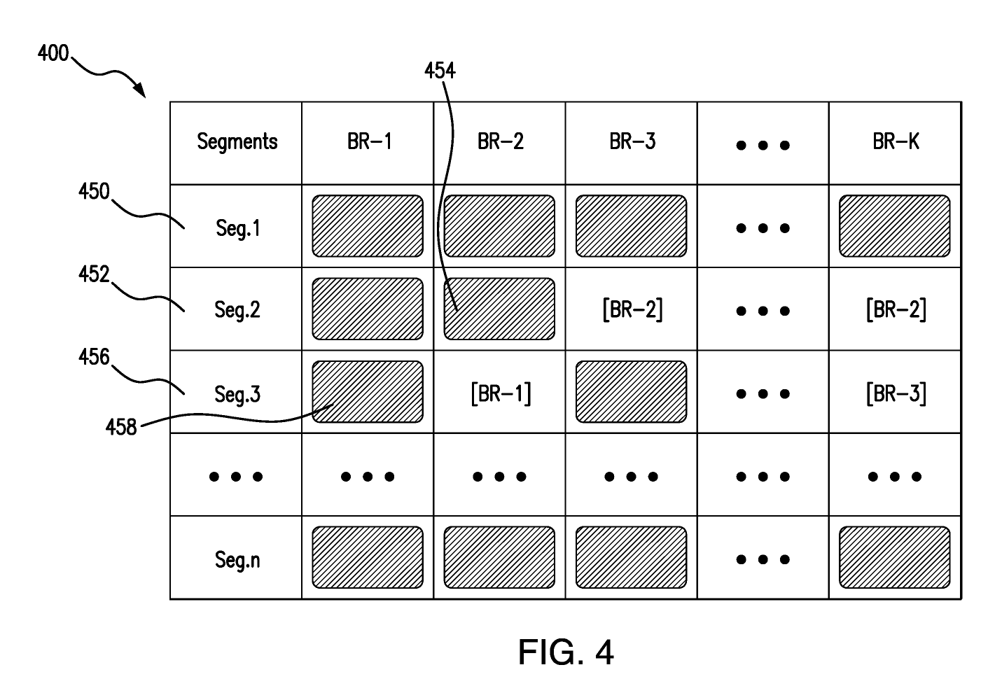

Embodiments of the disclosed subject matter provide a method or system that can remove redundancy in the number of bitrate levels and hence reduce the overall number of produced and stored segments at the adaptive streaming server. Furthermore, such a system can improve efficiency of the overall streaming platform by reducing bandwidth overhead while achieving the same quality of experience for end users. For example, a method for video streaming as described herein may include determining, for a video segment in a video sequence, a quality equivalence map between two or more bitrate levels. A bitrate level for the video segment may be selected based on an available bandwidth and the quality equivalence map. The video segment at the selected bitrate level may then be streamed. The quality equivalence map as further described herein (see, e.g., FIG. 4) can identify, for one or more bitrate levels of a video segment, a lower bitrate level with an equivalent perceived quality for the video segment. A bitrate level for a video segment may be selected by determining the highest bitrate level allowed by the available bandwidth and selecting the lowest bitrate level with an equivalent perceived quality to the determined highest bitrate level.

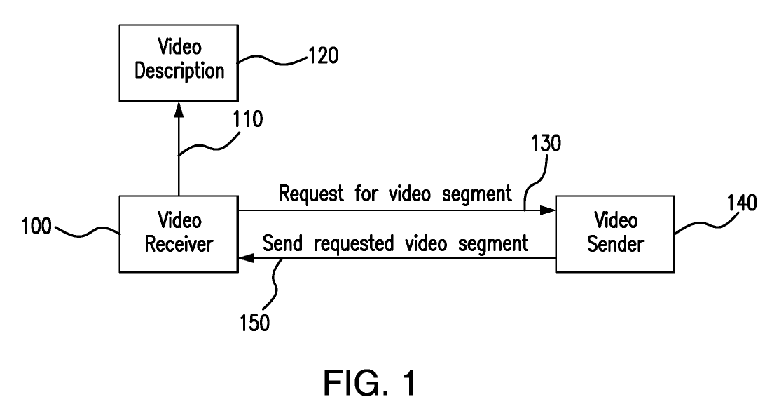

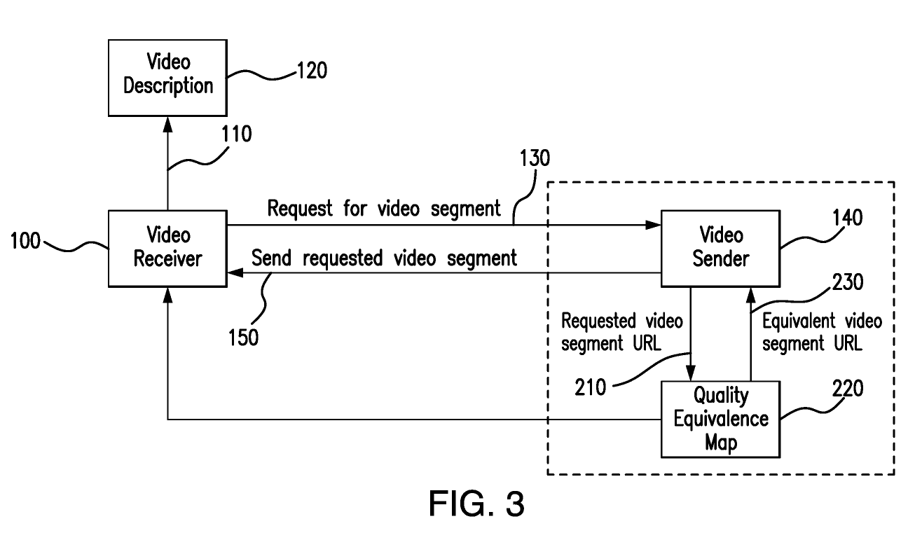

FIG. 3 is a diagram of an exemplary adaptive streaming system in accordance with the disclosed subject matter. The Fig. is similar to that shown in FIG. 1, except that it includes additional elements: Quality Equivalence Map (QEM) 220, a connection for sending requested video segment address or URL 210 and a connection for returning an equivalent video segment address or URL 230. Video receiver 100 may send a request to a video sender 140 for a video segment 130 at a specific bitrate selected from the video description 120.

Upon receiving the request, video sender can query the QEM 220 by forwarding the requested video segment address or URL or identification over connection 210. This connection can be realized as a connection to a local database or a link to an external server. QEM 220 can include one or more tables that map quality equivalence of all segments present at the video sender 140. QEM 220 may send back the address or URL of an equivalent video segment via the connection 230. Video sender 140 sends the equivalent video segment back to video receiver 100 for playback. The equivalent video segment can have the same or lower bitrate and same perceived quality as the requested video segment. The video sender 140 can determine the segment to be delivered based on current bandwidth availability and content features computed apriori or in realtime.

According to some embodiments of the disclosure, the video receiver 100 may have access to the quality equivalence map 220 either by storing a copy of the map 220 in a memory integrated with the video receiver 100, or by accessing an address to the map 220 at a remote location, such as a third party server or at the video sender 140. In this example, the video receiver 100 may, based on the bandwidth available between the video receiver 100 and the video sender 140 and the accessed quality equivalence map 200, directly request 130 a specific video segment encoded at a specific bitrate from the video sender 140. The video sender 140 may then send the requested video segment 150.

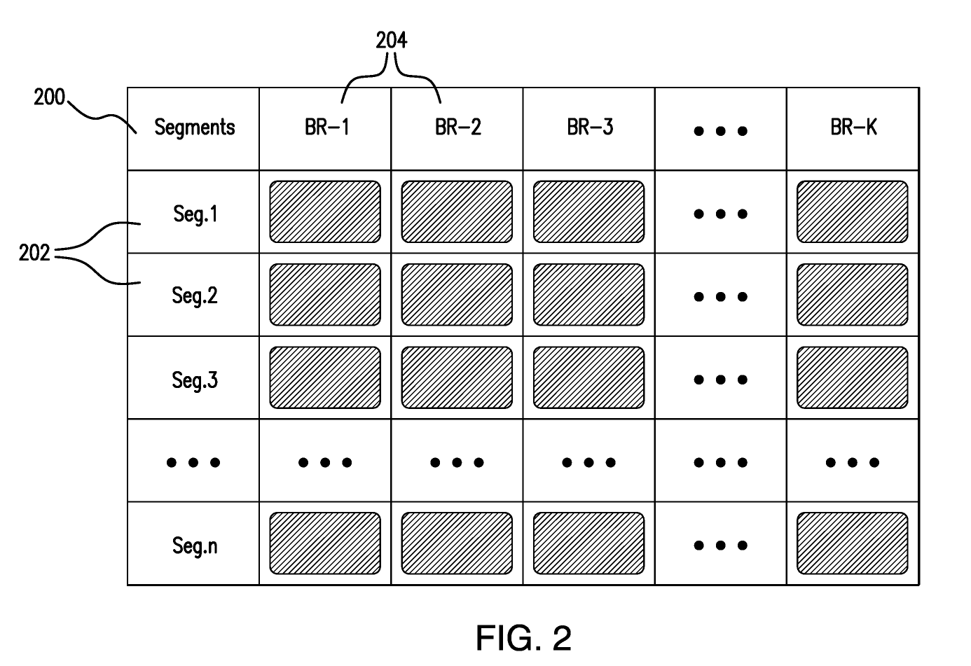

Quality equivalence map 200 allows for producing a reduced set of segments made available at the video sender 140. However, referring to FIG. 4, an equivalence map 400 of a reduced set of segments provided by an adaptive streaming system, according to some embodiments of the disclosed subject matter, is illustrated. Instead of using the full set of segments depicted in FIG. 2 the adaptive streaming system can use a reduced set depicted in FIG. 4. As shown by way of example and not limitation, the first segment 450 includes a full set of bitrate representations from bitrate level BR-1 to BR-K. For the second segment 452 equivalence map 400 shows that bitrate representations of level 3 and above (BR-3, BR-4, . . . , BR-K) can have a perceived quality equivalent to BR-2.

As shown in the equivalence map 400, the second segment 452 at level BR-3 may point to the second segment at level BR-2 454. Accordingly, if a second segment 452 representation above BR-2 is requested or determined, a video sender may retrieve from the QEM 400 a pointer to the second segment BR-2 representation 454. In another example, a third segment 456 at BR-2 representation can be equivalent to the BR-1 representation 458 of the third segment and hence if a level of BR-2 is requested a pointer to BR-1 is provided. However, as shown, BR-3 quality may not be equivalent to BR-1 and may instead be higher than BR-1. Thus BR-3 may not mapped to BR-1. Above level BR-3, for example, all representations may have quality equivalent to BR-3 and may be mapped to BR-3. This allows for storing and delivering only 2 out of possible K representations for both Seg. 2 and Seg. 3.

According to some embodiments, a video receiver may request a specific video segment at a specific bit rate, and the video sender may transmit a video segment at a lower bit rate but with an equivalent perceived quality based on a received or measured available bandwidth. In other embodiments, since the video sender may have or store the information on quality equivalence at various bitrate levels, a receiver can request a segment by providing a segment number and available bandwidth. The video sender 140 can use the QEM to determine the appropriate segment to send in response to the request.

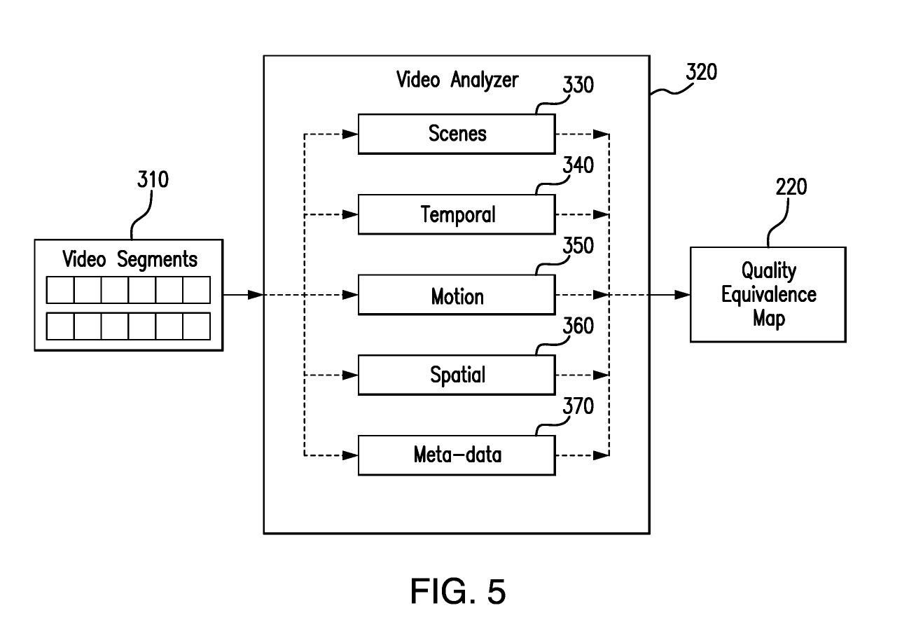

FIG. 5 is a diagram of an exemplary process of generating the QEM 220. As shown, a full set of video segments 310 can be input to a video analyzer (VA) component 320. Output of the VA may be the QEM 220 for the input segments set 310. Bitrate representations of a segment can be evaluated for a calculated quality factor QF. If difference in QF of two representations is below a predetermined threshold TQ:

QBR-2−QBR-1<TQ, (1)

the two bitrate representations may be designated as equivalent and their mapping can be added to QEM. The quality factor of a representation can be calculated based on a model that analyses content of the video segments in either a pixel or compressed domain and can employ HVS correlations to estimate subjective quality. Stages of this model are represented in FIG. 5 as separate components of VA: Scene component (SC) 330, Temporal component (T) 340, Motion component (M) 350, Spatial component (SP) 360 and Meta-data component (MD) 370. Input to each of those components can be the video segment in its entirety or parts of the content belonging to the segment that are sufficient for analysis carried out by the corresponding component. After the analysis is completed, weighted outputs of all components can be combined for the calculation of the final quality factor:

c1×QSC+c2×QT+c3×QM+c4×QSP+c5×QMD=QF (2)

where QSC, QT, QM, QSP and QMD are quality factor outputs of SC, T, M, SP and MD components respectively, and c1 through c5 are weighting coefficients that provide flexibility for different case scenarios. While a set of weighting coefficients may be determined for a model of HVS correlations, the set of weighting coefficients may also change based on the type of video segment that is being evaluated. For example, a different model may apply to different types of video segments such as video segments with fast motion or slow motion or video segments having high contrast. Quality equivalence between two bitrate levels can be determined based on objective quality metrics such as Peak Signal to Noise Ratio (PSNR) or other known methods for computing objective quality of video segments.

Quality of the SC component can be obtained by analyzing scene characteristics of the video segment. The information that is extracted relates to scene duration and scene changes. Scene duration, temporal dynamic of scene changes and strength of transition between subsequent scenes can be used to calculate QSC based on temporal masking. Segments with many scene transitions can tolerate more distortions because frames with impairments are masked by subsequent frames belonging to the next scene.

Quality of the T component can be obtained by analyzing frames belonging to one segment. The information about temporal transitions is extracted for spatially overlapping regions of subsequent frames in the video segment. Regions that exhibit significant change in luminosity and texture between two frames are temporally masked and thus can tolerate more distortions.

Quality of the M component can be obtained by analyzing motion information extracted from the segment content. Optical flow may be calculated between the subsequent frames in order to represent the motion present in the sequence. Optical flow can also be approximated by using motion estimation methods. Information about motion may be represented using motion vectors (MVs) that show the displacement of a frame region that occurs between subsequent frames. Using MVs, the velocity of moving regions is calculated based on MV magnitude:

V=\sqrt{MV_{X}²+MV_{Y}²} (3)

where MVX and MVY are horizontal and vertical components of MV.

Furthermore, the orientation of the motion is extracted by calculating the angle of motion:

$$A = arctan \frac{{MV}_{Y}}{{MV}_{X}} \qquad ( 4 )$$

where MVY and MVX are vertical and horizontal components of MV, and A is an angle between vector and horizontal axis.

Based on the velocity and orientation information a coherency of motion can be calculated and a motion masking model can be employed that allows for more distortions in the regions of high velocity based on the fact that human eyes cannot track those regions and hence the perceived visual image is not stabilized on the retina.

Quality of the SP component can be obtained using the spatial masking model based on the texture and luminosity information extracted from the content of the video segment. Contrast sensitivity function (CSF) and just-noticeable-difference (JND) are used to calculate distortion tolerability for all frames in the sequence. Necessary information can be obtained either from pixel or compressed domain.

Quality of the MD component can be obtained by analyzing metadata that is provided with the input segments or the whole video sequence or the receiver metadata. Metadata about the content can include presence of speech, emotional speech, subtitles, close captioning, transcript, screenplay, critic review, or consumer review. Receiver meta data can include receiver display size, information on the receiver playback environment, ambient light and sound conditions at the receiver. Receiver metadata can be transmitted to the sender as a part of segment request.

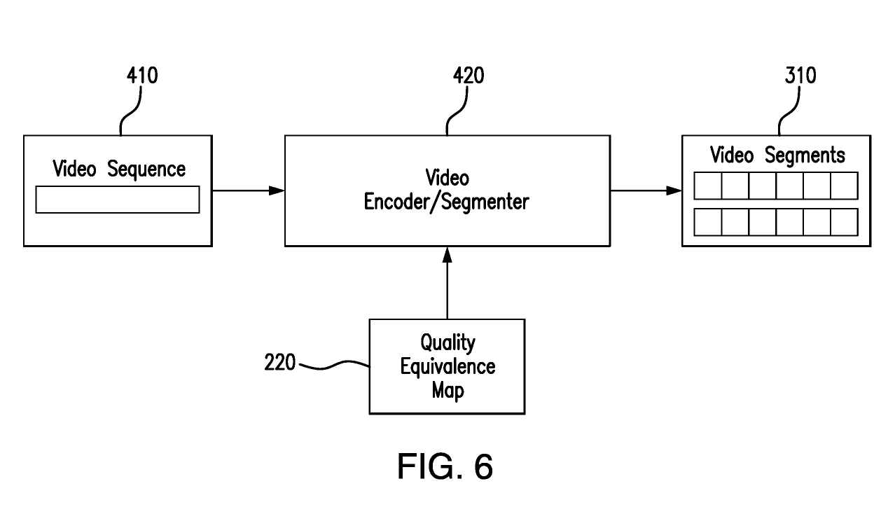

A process of generating QEM can be implemented at the time of video encoding and segmentation. FIG. 6 depicts a schematic diagram of an exemplary video encoding process, according to embodiments of the disclosed subject matter. A video sequence 410 may be an input to a component 420 that represents a video encoder and segmenter. The analysis functionality described as part of video analyzer 320 may be implemented as a part of the video encoder/segmenter 420. The output of video encoder 420 may be a set of video segments 310 and QEM 220. The encoder/segmenter 420 outputs video at one or more bitrate representations and optionally splits the output video into two or more segments.

According to some embodiments, video encoder 420 may receive a video sequence that includes a plurality of video segments. Alternatively, the received video sequence may not yet be segmented, and the video encoder 420 may initially divide the video sequence into a plurality of temporal video segments. The video encoder 420 may determine or generate a quality equivalence map 220 for the plurality of video segments that identifies perceived quality equivalence between two or more bitrate levels for each of the video segments. Based on the generated quality equivalence map 220, the video encoder 420 may encode the video segments at one or more bitrate levels. The encoded set of video segments may, for example, be a reduced set. For a video segment that can be represented by K bitrate levels, the quality equivalence map may identify one or more bitrate levels that have the same perceived quality. For example and not by limitation, the quality equivalence map may identify bitrate levels 1-3 have a first level of perceived quality, bitrate levels 4-6 have a second level of perceived quality, and bitrate levels 7-K have a third level of perceived quality. The encoded representation of the video segment may only require three representations instead of K representations for each bitrate level. In some embodiments, the video encoder 420 and quality equivalence map 220 may reside with or be integrated with a video sender (e.g., video receiver 140 of FIG. 1).

The disclosed subject matter provides a system and means of obtaining QEM for either the set of already produced segments or any video sequence at the time of encoding and segmentation. Furthermore, the disclosed subject matter describes a way of implementing QEM in the adaptive streaming system such that aforementioned system redundancies are minimized.

Although the disclosed subject matter has been described by way of examples of embodiments, it is to be understood that various other adaptations and modifications may be made within the spirit and scope of the disclosed subject matter.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture can provide functionality of the disclosed methods as a result of one or more processor executing software embodied in one or more tangible, computer-readable media. The software implementing various embodiments of the present disclosure can be stored in memory and executed by processor(s). A computer-readable medium can include one or more memory devices, according to particular needs. A processor can read the software from one or more other computer-readable media, such as mass storage device(s) or from one or more other sources via communication interface. The software can cause processor(s) to execute particular processes or particular parts of particular processes described herein, including defining data structures stored in memory and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

1. A method of video streaming, comprising:
determining, for a video segment in a video sequence, a quality equivalence map between two or more bitrate levels;
selecting a bitrate level for the video segment based on an available bandwidth and the determined quality equivalence map; and
streaming the video segment at the selected bitrate level.

2. The method of claim 1, wherein the quality equivalence map identifies, for one or more bitrate levels, a lower bitrate level with an equivalent perceived quality.

3. The method of claim 1, wherein the selecting a bitrate level for the video segment comprises: determining the highest bitrate level allowed by the available bandwidth; and
selecting a lowest bitrate level with an equivalent perceived quality to the determined highest bitrate level.

4. The method of claim 1, further comprising calculating a quality factor for the video segment at each bitrate level.

5. The method of claim 4, wherein the calculating a quality factor at a bitrate level comprises using a Human Visual System model that correlates perceived quality with analysis components of the video segment at the bitrate level.

6. The method of claim 5, wherein the analysis components comprises any of: a scene component, temporal component, motion component, spatial component, and a metadata component.

7. The method of claim 1, further comprising determining a difference between quality factors of two bitrate levels; and
identifying a perceived quality equivalence between the two bitrate levels if the difference between quality factors is less than a predetermined threshold.

8. The method of claim 1, further comprising storing a reduced set of video segments at different bitrate levels, based on the determined quality equivalence map.

9. A method of video encoding, comprising:
receiving a video sequence comprising a plurality of video segments;
determining a quality equivalence map for the plurality of video segments that identifies perceived quality equivalence between two or more bitrate levels for each of the video segments; and
encoding the plurality of video segments at one or more bitrate levels based on the quality equivalence map.

10. The method of claim 9, comprising transmitting the plurality of video segments based on an available bandwidth.

11. The method of claim 9, wherein the determining a quality equivalence map for the plurality of video segments comprises calculating a quality factor for each video segment at a plurality of bitrate levels.

12. The method of claim 11, wherein the calculating a quality factor for a video segment at a bitrate level comprises using a Human Visual System model that correlates perceived quality with analysis components of the video segment at the bitrate level.

13. The method of claim 9, wherein the quality equivalence map identifies, for one or more bitrate levels of a video segment, a lower bitrate level with an equivalent perceived quality.

14. A system for adaptive streaming, comprising:
a video receiver configured to transmit a request for a video segment;
a video analyzer configured to determine, for the video segment, a quality equivalence map between two or more bitrate levels; and
a video sender coupled to the video analyzer configured to:
select a bitrate level for the video segment based on an available bandwidth and the determined quality equivalence map; and
transmit, to the video receiver, the video segment at the selected bitrate level.

15. The system of claim 14, wherein the quality equivalence map identifies, for one or more bitrate levels, a lower bitrate level with an equivalent perceived quality.

16. The system of claim 14, wherein the video sender is configured to select a bitrate level for the video segment by:
determining the highest bitrate level allowed by the available bandwidth; and
selecting the lowest bitrate level with an equivalent perceived quality to the determined highest bitrate level.

17. The system of claim 14, wherein the video analyzer is configured to determine a quality equivalence map by:
calculating a quality factor for the video segment at each bitrate level;
determining a difference between quality factors of two bitrate levels; and
identifying a perceived quality equivalence between the two bitrate levels if the difference between quality factors is less than a predetermined threshold

18. The system of claim 17, wherein the calculating a quality factor at a bitrate level is based on a Human Visual System model that correlates perceived quality with analysis components of the video segment at the bitrate level.

19. A system for adaptive streaming, comprising:
a video analyzer configured to determine, for a video segment, a quality equivalence map between two or more bitrate levels;
a video receiver configured to:
access the quality equivalence map and select a bitrate level for the video segment based on an available bandwidth and the accessed quality equivalence map; and
transmit a request to a video sender for the video segment at the selected bitrate level;
wherein the video sender is configured to transmit, to the video receiver, the requested video segment.

20. A non-transitory computer readable medium comprising instructions to perform the method of claim 1.
